(19) United States
(12) Patent Application Publication
(10) Pub. No.: US 2013/0021327 A1
(43) Pub. Date: Jan. 24, 2013

(54) IMAGE CONTROL DEVICE AND IMAGE DISPLAYING SYSTEM COMPRISING THE SAME

(71) Applicant: Chia Chan HU, Taoyuan Hsien (TW)

(72) Inventor: Chia Chan HU, Taoyuan Hsien (TW)

(73) Assignee: DELTA ELECTRONICS, INC., Taoyuan Hsien (TW)

(21) Appl. No.: 13/450,674

(22) Filed: Apr. 19, 2012

(30) Foreign Application Priority Data
Jul. 20, 2011 (TW) 100125554

(51) Int. Cl. G06T 15/00

(52) U.S. Cl. 345/419

(57) ABSTRACT

An image control device and an image displaying system comprising the same are provided. The image control device co-operates with a displaying device of the image displaying system. When a proximity sensor of the image control device senses proximity of a user, it generates a three-dimensional image activation signal for informing the displaying device to play a three-dimensional image so that the user can watch the three-dimensional image through three-dimensional image filter units of the image control device. When the proximity sensor of the image control device senses the leaving of the user, it generates a three-dimensional image ending signal for informing the displaying device to stop displaying the three-dimensional image.

This application claims priority to Taiwan Patent Application No. 100125554 filed on Jul. 20, 2011, which is hereby incorporated by reference in its entirety.

### CROSS-REFERENCES TO RELATED APPLICATIONS

Not applicable.

### BACKGROUND OF THE INVENTION

1. Field of the Invention

The present invention relates to an image control device and an image displaying system comprising the image control device. More particularly, the image control device of the present invention automatically controls a displaying device of the image displaying system to display a three-dimensional (3D) image according to use conditions of the image displaying system.

2. Descriptions of the Related Art

As the technologies of three-dimensional (3D) image displaying have become sophisticated gradually, their applications have also extended from the enterprises to the household field gradually so that high-quality videos can also be enjoyed by the general public in the personal environments. However, in the prior art, when a common user is to watch a 3D film by using a 3D displaying device, he usually must activate the 3D image displaying function of a player firstly and then make corresponding 3D image displaying settings through a menu of the 3D displaying device. In this way, the user can watch the 3D image through a pair of 3D glasses.

However, the technologies of 3D image displaying are new technologies, so making settings in a manual manner will cause inconveniences to the user in watching the 3D film if the user is unfamiliar with operations related to 3D images of the player and the displaying device, and this may further significantly reduce the user's intention to purchase a device for displaying 3D images. Accordingly, how to enable the user to manipulate the displaying of 3D images in a more convenient way becomes an important problem at present.

According to the above descriptions, an urgent need exists in the art to make manipulation of the displaying of 3D images simpler so as to enhance the user's intention to purchase a device for displaying 3D images.

### SUMMARY OF THE INVENTION

To solve the problem associated with manipulating a device for displaying 3D images, the present invention provides an image control device and an image displaying system comprising the image control device. The image displaying system can automatically make settings related to the 3D image displaying in the image displaying system by mainly using the image control device to detect use conditions of the image displaying system.

To achieve the aforesaid objective, the present invention provides an image control device, which co-operates with a displaying device. The image control device comprises a housing, a proximity sensor, a transceiver and 3D image filter units. The proximity sensor, which is disposed on the housing, is configured to generate a 3D image activation signal after sensing proximity of a user. The transceiver, which is disposed on the housing and is electrically connected to the proximity sensor, is configured to transmit the 3D image activation signal to a displaying device so that the displaying device outputs a 3D image. The 3D image filter units, which are disposed on the housing, are configured to filter the 3D image displayed by the displaying device.

To achieve the aforesaid objective, the present invention also provides an image displaying system, which comprises an image control device and a displaying device. The image control device comprises a housing, a proximity sensor, a first transceiver and 3D image filter units. The proximity sensor, which is disposed on the housing, is configured to generate a 3D image activation signal after sensing proximity of a user. The first transceiver, which is disposed on the housing and is electrically connected to the proximity sensor, is configured to transmit the 3D image activation signal. The 3D image filter units, which are disposed on the housing, are configured to filter a 3D image.

The displaying device comprises an input terminal, a second transceiver, an image processing unit and a displaying unit. The input terminal is configured to receive an image signal from an image output device. The second transceiver is configured to receive the 3D image activation signal transmitted from the first transceiver. The image processing unit, which is electrically connected to the input terminal and the second transceiver, is configured to transform the image signal into the 3D image according to the 3D image activation signal. The displaying unit, which is electrically connected to the image processing unit, is configured to display the 3D image.

With the technical features disclosed above, the image control device and the image displaying system comprising the same according to the present invention can automatically assist a user in manipulating the displaying of 3D images in a more convenient way.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of an image displaying system according to a first embodiment of the present invention;

FIG. 1B is a front view of an image control device according to the first embodiment of the present invention;

FIG. 2A is a schematic view of an image displaying system according to a second embodiment of the present invention;

FIG. 2B is a front view of an image control device according to the second embodiment of the present invention; and

FIG. 3 is a schematic view of an image displaying system according to a third embodiment of the present invention.

### DESCRIPTION OF THE PREFERRED EMBODIMENT

In the following descriptions, the present invention will be explained with reference to embodiments thereof. However, these embodiments are not intended to limit the present invention to any specific environment, applications or particular implementations described in these embodiments. Therefore, description of these embodiments is only for purpose of illustration rather than to limit the present invention. It shall be appreciated that, in the following embodiments and the attached drawings, elements not directly related to the present invention are omitted from depiction.

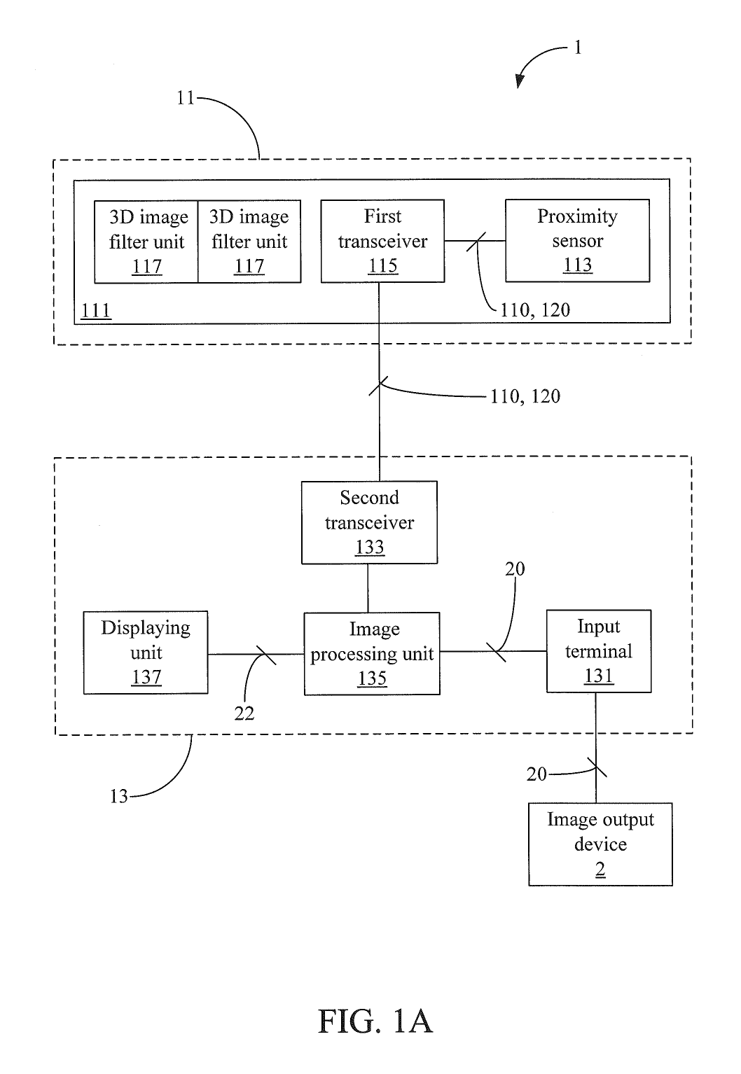

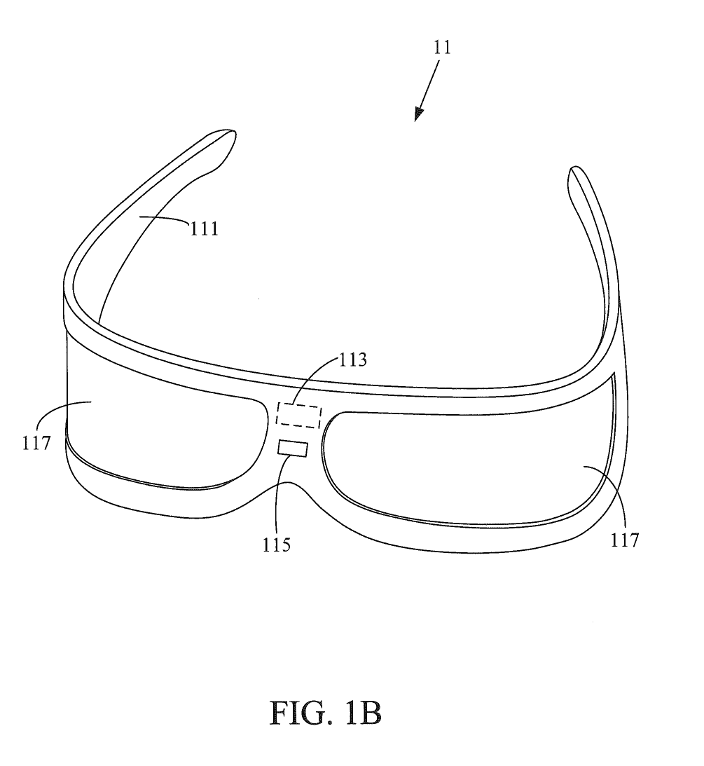

Referring firstly to FIG. 1A, there is shown a schematic view of an image displaying system 1 according to a first embodiment of the present invention. The image displaying system 1 comprises an image control device 11 and a displaying device 13, and the image control device 11 co-operates with the displaying device 13. The image control device 11 comprises a housing 111, a proximity sensor 113, a first transceiver 115 and two three-dimensional (3D) image filter units 117. The proximity sensor 113 is electrically connected to the first transceiver 115.

The displaying device 13 comprises an input terminal 131, a second transceiver 133, an image processing unit 135 and a displaying unit 137. The input terminal 131, the second transceiver 133 and the displaying unit 137 are all electrically connected to the image processing unit 135. Hereinafter, relationships between and functions of the elements of this image displaying system will be described in detail.

In detail, on the side of the image control device 11, the proximity sensor 113 is configured to generate a 3D image activation signal 110 after sensing proximity of a user; and the first transceiver 115 is configured to transmit the 3D image activation signal 110 to the displaying device 13 so as to inform the displaying device 13 that the user desires to watch a 3D image.

On the other hand, on the side of the displaying device 13, the input terminal 131 firstly receives an image signal 20 from an image output device 2; and after the 3D image activation signal 110 transmitted from the first transceiver 115 is received by the second transceiver 133, the image processing unit 135 transforms the image signal 20 received by the input terminal 131 into a 3D image 22 according to the 3D image activation signal 110, and displays the 3D image 22 on the displaying unit 137. In this way, when the user watches the 3D image 22 displayed on the displaying unit 137 through the 3D image filter units 117, a 3D visual effect can be achieved.

Specifically, referring to FIG. 1B together, there is shown a front view of the image control device 11 according to the first embodiment of the present invention. As shown, the proximity sensor 113, the first transceiver 115 and the 3D image filter units 117 of the image control device 11 in the first embodiment are all disposed on the housing 111. It shall be particularly emphasized that, the image control device 11 of the present invention is implemented as a pair of 3D glasses; however, this is not intended to limit the forms thereof, and people skilled in the art may implement the image control device in various forms upon reviewing the disclosure of the present invention.

Next, in more detail, when the user desires to watch 3D images, the user may place the image control device 11 at positions corresponding to the eyes on the face directly. Then, the proximity sensor 113 senses proximity of an object (i.e., the user) and generates the 3D image activation signal 110 in response to this. After receiving the 3D image activation signal 110, the first transceiver 115 transmits the 3D image activation signal 110 to the displaying device 13 so that the displaying device 13 outputs the 3D image 22 to the displaying unit 137 according to the 3D image activation signal 110 in the way described above. In this way, by filtering the 3D image 22 through the 3D image filter units 117, a 3D visual effect can be presented to the user.

Additionally, it shall be particularly appreciated that, if the image signal 20 originally outputted by the image output device 2 is already a 3D image, then the image processing unit 135 can directly transmit the image signal 20 to the displaying unit 137 as the 3D image 22 after the image signal 20 is received by the input terminal 131 so that the displaying unit 137 outputs the 3D image 22 directly. However, if the image signal 20 originally outputted by the image output device 2 is only a 2D image, the image processing unit 135 must firstly transform the image signal 20 into the 3D image 22 and then transmit the 3D image 22 to the displaying unit 137.

When the user desires to stop watching the 3D image, the image control device 11 can be removed directly. Correspondingly, the proximity sensor 113 senses separation from the user and generates a 3D image ending signal 120. Then, the first transceiver 115 transmits the 3D image ending signal 120 to the image processing unit 135 via the second transceiver 133; and the image processing unit 135 stops transforming the image signal 20 into the 3D image 22 according to the 3D image ending signal 120.

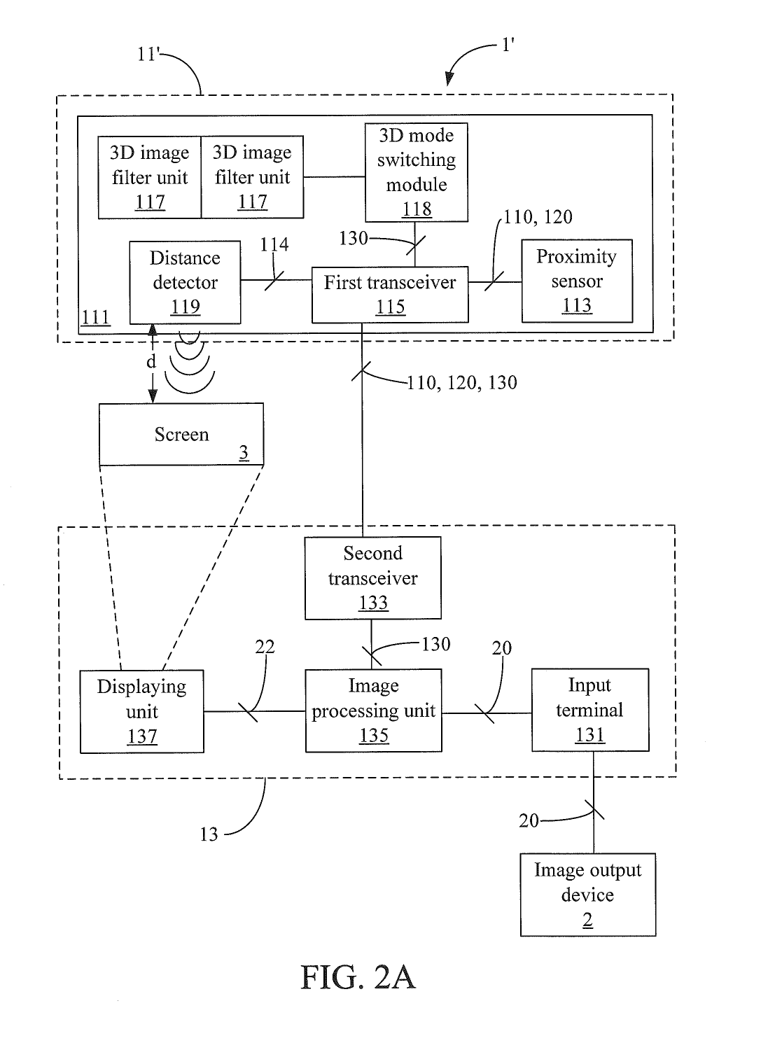

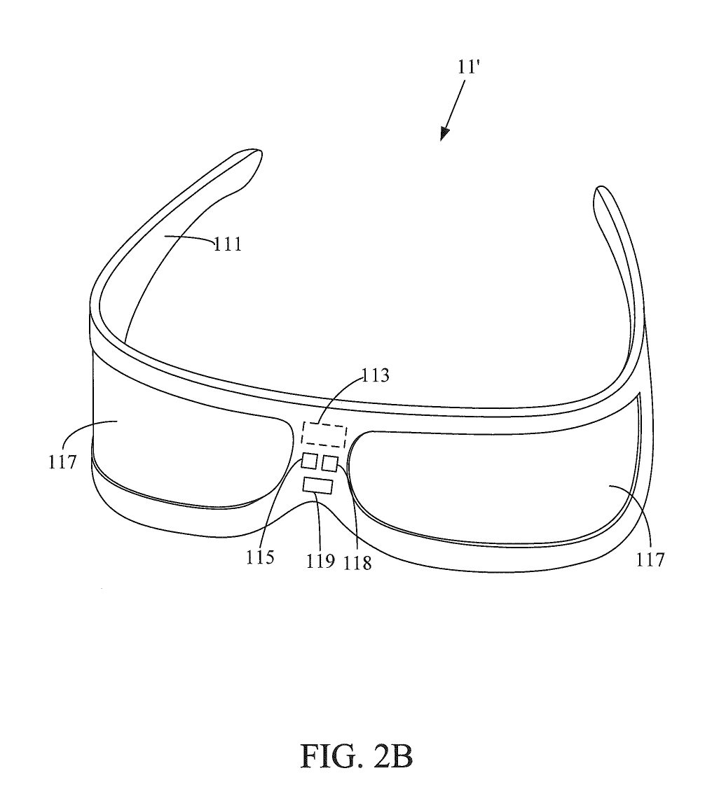

Referring next to FIG. 2A and FIG. 2B, FIG. 2A is a schematic view of an image displaying system 1′ according to a second embodiment of the present invention; and FIG. 2B is a front view of an image control device 11′ according to the second embodiment of the present invention. The image displaying system 1′ comprises the image control device 11′ and a displaying device 13, and the image control device 11′ co-operates with the displaying device 13. The elements of the second embodiment that are the same as those of the first embodiment also have the same functions, and thus will not be further described herein.

It shall be particularly appreciated that, the second embodiment differs from the first embodiment in that: as compared with the image control device 11 of the first embodiment, the image control device 11′ of the second embodiment further comprises a 3D mode switching module 118. The 3D mode switching module 118 is electrically connected to the first transceiver 115 and the 3D image filter units 117. Specifically, in the second embodiment, when the 3D image activation signal 110 is received by the displaying device 13 from the image control device 11′, it means that the user is using the image control device 11′; and because the 3D image 22 may have different attributes and properties, the displaying device 13 must inform the 3D image filter units 117 of the image control device 11′ to make corresponding adjustment.

In detail, when the image signal 20 is received by the input terminal 131 of the displaying device 13 from the image output device 2, the image processing unit 135 transforms the image signal 20 into the 3D image 22 and also determines the attribute and property of the 3D image 22. Then, the image processing unit 135 generates a 3D mode signal 130 according to the 3D image 22 and, through the second transceiver 133, transmits the 3D mode signal 130 to the 3D mode switching module 118 via the first transceiver 115 of the image control device 11′. In this way, the 3D mode switching module 118 can switch an image filter mode of the 3D image filter units 117 according to the 3D mode signal 130.

For example, for the existing 3D technology that utilizes the visual angle difference, each 3D image frame must be comprised of two frames having an angular shifting therebetween, and only after the two frames are filtered by two 3D image filter units, the two frames captured by both eyes of the user can be recombined into a stereoscopic image in the brain. However, in addition to the angles, another property of the frames of the 3D image is the displaying frequency. Therefore, in order to display the 3D image to be more realistic, the 3D mode switching module can be used to inform the 3D image filter units to make corresponding adjustment in terms of the 3D image filtering depending on different properties of the 3D image.

In addition, as compared with the image control device 11 of the first embodiment, the image control device 11′ of the second embodiment further comprises a distance detector 119 which is electrically connected to the first transceiver 115. Specifically, when the user watches the 3D image for a long time, visual fatigue is often caused due to the stereoscopic image effect. In this case, the user can be relieved through adjustment of a depth of the 3D image.

In detail, when the displaying device 13 of the second embodiment is implemented as a projector, the 3D image 22 must be projected onto a screen 3 to make it convenient for the user to watch. In other words, an imaging location of the 3D image 22 is the screen 3. In this case, because the image control device 11′ is worn on the user, a relative distance between the user and the screen 3 can be determined by means of the distance detector 119 of the image control device 11′. Further speaking, the distance detector 119 of the image control device 11′ is configured to measure a distance d between the image control device 11′ and the screen 3 within a time period and to generate a distance signal 114 according to the distance d.

Then, the first transceiver 115 transmits the distance signal 114 to the image processing unit 135 via the second transceiver 133 so that the image processing unit 135 adjusts a depth attribute of the 3D image 22 according to the distance d represented by the distance signal 114. In other words, by using the image processing unit 135 to adjust the depth attribute of the 3D image 22, the displaying device 13 allows the user to obtain an optimal watching status.

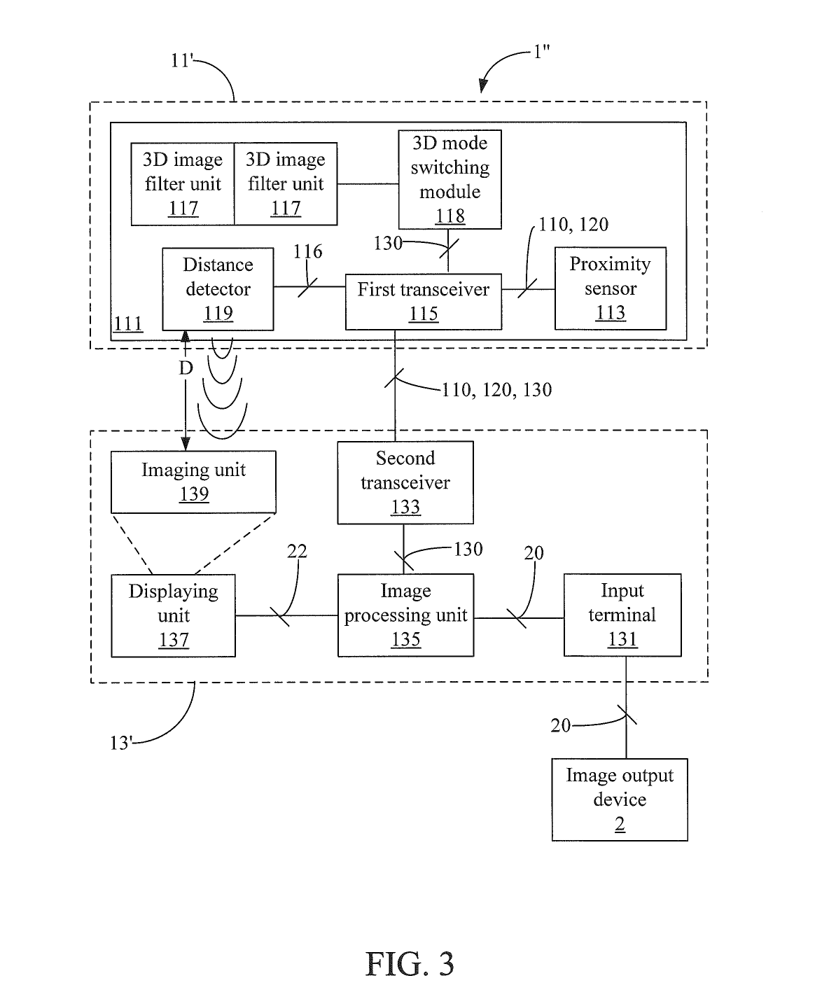

Referring next to FIG. 3, there is shown a schematic view of an image displaying system 1″ according to a third embodiment of the present invention. The image displaying system 1″ comprises an image control device 11′ and a displaying device 13′, and the image control device 11′ co-operates with the displaying device 13′. The elements of the third embodiment that are the same as those of the second embodiment also have the same functions, and thus will not be further described herein.

It shall be particularly appreciated that, the third embodiment differs from the second embodiment in that: the displaying device 13′ of the third embodiment is implemented as a common display screen, so it further comprises an imaging unit 139. Specifically, the displaying device 13′ of the third embodiment has the 3D image 22 imaged onto the imaging unit 139 to make it convenient for the user to watch. In other words, an imaging location of the 3D image 22 is the imaging unit 139. In this case, because the image control device 11′ is worn on the user, a relative distance between the user and the imaging unit 139 of the displaying device 13′ can be determined by means of the distance detector 119 of the image control device 11′.

Similarly, the distance detector 119 of the image control device 11′ is configured to measure a distance D between the image control device 11′ and the imaging unit 139 of the displaying device 13′ within a time period and to generate a distance signal 116 according to the distance D. Then, the first transceiver 115 transmits the distance signal 116 to the second transceiver 133 so that, after receiving the distance signal 116, the image processing unit 135 adjusts a depth attribute of the 3D image 22 according to the distance D represented by the distance signal 116. In other words, by using the image processing unit 135 to adjust the depth attribute of the 3D image 22, the displaying device 13′ allows the user to obtain an optimal watching status.

According to the above descriptions, the image displaying system of the present invention can use the image control device to automatically control displaying of 3D images. Thus, the shortcoming of inconvenience in manipulating the displaying of 3D images in the prior art can be readily overcome.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An image displaying system, comprising:
an image control device comprising:
a housing;
a proximity sensor, which is disposed on the housing, being configured to generate a three-dimensional (3D) image activation signal after sensing proximity of a user;
a first transceiver, which is disposed on the housing and is electrically connected to the proximity sensor, being configured to transmit the 3D image activation signal; and
two 3D image filter units, which are disposed on the housing, being configured to filter a 3D image; and
a displaying device, comprising:
an input terminal being configured to receive an image signal from an image output device;
a second transceiver being configured to receive the 3D image activation signal transmitted from the first transceiver;
an image processing unit, which is electrically connected to the input terminal and the second transceiver, being configured to transform the image signal into the 3D image according to the 3D image activation signal; and
a displaying unit, which is electrically connected to the image processing unit, being configured to display the 3D image.

2. The image displaying system as claimed in claim 1, wherein the image control device further comprises a 3D mode switching module which is connected to the first transceiver and the 3D image filter units electrically, the image processing unit is further configured to generate a 3D mode signal according to the 3D image, the second transceiver is further configured to transmit the 3D mode signal to the 3D mode switching module via the first transceiver, and the 3D mode switching module switches an image filter mode of the 3D image filter units according to the 3D mode signal.

3. The image displaying system as claimed in claim 1, wherein the image control device further comprises a distance detector which is connected to the first transceiver electrically, the displaying device further comprises an imaging unit, the 3D image is imaged on the imaging unit, the distance detector is configured to measure a distance between the image control device and the imaging unit within a time period and to generate a distance signal according to the distance, the first transceiver is further configured to transmit the distance signal to the image processing unit via the second transceiver, and the image processing unit is further configured to adjust a depth attribute of the 3D image according to the distance signal.

4. The image displaying system as claimed in claim 1, wherein the image control device further comprises a distance detector which is connected to the first transceiver electrically, the displaying unit is configured to display the 3D image on a screen, the distance detector is further configured to measure a distance between the image control device and the screen within a time period and to generate a distance signal according to the distance, the first transceiver is further configured to transmit the distance signal to the image processing unit via the second transceiver, and the image processing unit is further configured to adjust a depth attribute of the 3D image according to the distance signal.

5. The image displaying system as claimed in claim 1, wherein the proximity sensor is further configured to generate a 3D image ending signal after sensing leaving of the user, the first transceiver is further configured to transmit the 3D image ending signal to the image processing unit via the second transceiver, and the image processing unit is further configured to cease transforming the image signal into the 3D image according to the 3D image ending signal.

6. An image control device, which co-operates with a displaying device, comprising:
a housing;
a proximity sensor, which is disposed on the housing, being configured to generate a three-dimensional (3D) image activation signal after sensing proximity of a user;
a transceiver, which is disposed on the housing and is electrically connected to the proximity sensor, being configured to transmit the 3D image activation signal to a displaying device so that the displaying device outputs a 3D image; and
two 3D image filter units, which are disposed on the housing, being configured to filter the 3D image.

7. The image control device as claimed in claim 6, further comprising:
a 3D mode switching module, which is electrically connected to the transceiver and the 3D image filter units;
wherein the transceiver is further configured to receive a 3D mode signal transmitted from the displaying device after the displaying device outputs the 3D image, and the 3D mode switching module is configured to switch an image filter mode of the 3D image filter units according to the 3D mode signal.

8. The image control device as claimed in claim 6, further comprising:
a distance detector, which is electrically connected to the transceiver, being configured to measure a distance between the image control device and an imaging location of the 3D image within a time period and to generate a distance signal according to the distance;
wherein the transceiver is further configured to transmit the distance signal to the displaying device so that the displaying device adjusts a depth attribute of the 3D image.

9. The image control device as claimed in claim 6, wherein the proximity sensor is further configured to generate a 3D image ending signal after sensing leaving of the user, and the transceiver is further configured to transmit the 3D image ending signal to the displaying device so that the displaying device ceases outputting the 3D image.
